(19) United States
(12) Patent Application Publication
(10) Pub. No.: US 2009/0232448 A1
(43) Pub. Date: Sep. 17, 2009

(54) Fiber optic multiplexer

(75) Inventors: Sunya Barmash, Fair Lawn, NJ (US); Boris Kavalerchik, Fair Lawn, NJ (US); Guang Liang, Elmhurst, NY (US); Eugene Shalyt, Washington Township, NJ (US); Peter Bratin, Flushing, NY (US)

Correspondence Address: D. MORGAN TENCH, 1180 CORTE RIVIERA, CAMARILLO, CA, 93010, US

(73) Assignee: ECI Technology, Inc.

(21) Appl. No.: 12/228,009

(22) Filed: Aug. 7, 2008

Related U.S. Application Data
(60) Provisional application No. 61/069,448, filed on Mar. 14, 2008.
(60) Provisional application No. 61/131,593, filed on Jun. 9, 2008.

(51) Int. Cl. G02B 6/26

(52) U.S. Cl. 385/26

(57) ABSTRACT

A fiber optic multiplexer comprises a stationary frame to which primary and secondary optical fibers are attached, a rotary frame to which both ends of a transfer optical fiber are attached, and a means of rotating the rotary frame through a predetermined angle relative to the stationary frame. The primary end of the transfer optical fiber is coaxial with the primary optical fiber and the rotary frame axis of rotation. The secondary end of the transfer optical fiber is initially coaxial with a first secondary optical fiber. The multiplexer is switched by rotating the rotary frame through the predetermined angle to coaxially align the secondary end of the transfer optical fiber with a second secondary optical fiber.

### CROSS-REFERENCE TO RELATED APPLICATIONS

The present nonprovisional application claims priority to U.S. Provisional Application No. 61/069,448 entitled “Fiber Optic Multiplexer” to Barmash et al. (filed on 14 Mar. 2008) and to U.S. Provisional Application No. 61/131,593 entitled “Improved Fiber Optic Multiplexer” to Barmash et al. (filed on 9 Jun. 2008), which all have the same inventors and the same assignee.

### BACKGROUND OF THE INVENTION

1. Field of the Invention

This invention is concerned with fiber optic systems, and particularly with switching electromagnetic radiation between optical fibers.

2. Description of the Related Art

Fiber optic systems are widely used to convey electromagnetic radiation from one location to another location in order to control industrial processes. For example, an optical fiber may be used to convey a measurement beam from a source of electromagnetic radiation to an analysis cell containing a sample of a processing solution to be analyzed by spectroscopy, and another optical fiber may be used to convey the measurement beam, having passed through the sample of the processing solution, to a detector for spectroscopic analysis. In this case, a fiber optic multiplexer enables analysis of a plurality of processing solutions, including different types of processing solutions, using the same analysis instrumentation, providing considerable cost savings.

In one prior art approach to optical multiplexing, input beams from multiple input optical fibers are projected into a single receiving fiber and selected using a shutter operated by a solenoid. Since the input fibers are stationary and have a finite diameter, the beams in this case must impinge the end of the receiving fiber at a substantial angle (relative to the axis of the receiving fiber) and/or from a substantial distance, which greatly increases the noise level and decreases the signal strength.

In another prior art approach to optical multiplexing, input beams from multiple input optical fibers are fed into an averaging sphere that has a highly reflecting interior surface. In this case, multiple reflections inside the averaging sphere provide coaxial beams to the receiving fiber but also greatly decrease the beam intensity. This approach typically provides less than 0.1% beam transmission, resulting in low signal-to-noise ratio. An analogous prior art approach involving a mode mixer comprising a cylinder with highly reflective interior sidewalls also provides low beam transmission and low signal-to-noise ratio.

Another prior art approach to optical multiplexing involves use of a rotating mirror or prism to reflect input beams from multiple input optical fibers coaxially onto a receiving optical fiber. One disadvantage of this approach is that the input beams must traverse a relatively large distance through the atmosphere between the input optical fibers and the receiving optical fiber. In this case, moisture and contaminants in the atmosphere may interfere with spectroscopic analyses, especially those involving near infrared (NIR) radiation at wavelengths strongly absorbed by water. Mirrors also tend to tarnish and collect dust from the atmosphere, which can significantly degrade the signal-to-noise ratio. Enclosing the multiplexer in a vacuum chamber can mitigate these disadvantages but is inconvenient and significantly increases equipment and operating costs.

Another prior art approach to optical multiplexing provides coaxial beam transfer between input optical fibers and a receiving optical fiber via a rotating wheel to which either the input fibers are attached or the receiving fiber is attached. Each of the input optical fibers can be positioned coaxial with and in close proximity to the receiving optical fiber, which provides efficient beam transfer, by rotating the wheel to predetermined positions. A major disadvantage of this prior art approach is that rotation of the wheel twists and stresses optical fibers attached to the wheel, which causes erratic results and introduces significant noise.

Because of the limitations of prior art devices and methods, there is a need for an optical multiplexer providing efficient and cost effective switching between light beams. In particular, such an optical multiplexer would be beneficial to the chemical, semiconductor and biotechnological industries which utilize many processes that require real-time analysis and control of a chemical reaction.

In the semiconductor industry, for example, etching of semiconductor wafers is an important process, typically involving a thin layer of silicon oxide (or silicon nitride) on the surface of a silicon wafer. The etching process is usually performed in an aqueous etchant solution based on a hydrogen fluoride etchant. Because of the thin layers and fine circuitry features involved, the etch rate must be closely controlled to provide acceptable results with high yield. It is also important to control other semiconductor processes, such as surface preparation and cleaning processes, which often involve some mild etching.

As described in U.S. Pat. No. 7,351,349 to Shekel et al. (issued 1 Apr. 2008), near infrared (NIR) spectroscopic analysis coupled with chemometric data manipulation can be used to provide effective real-time analysis and control of chemical processing solutions, including various types of solutions employed for semiconductor processing. The fiber optic multiplexer of the present invention enables multiple processing solutions to be analyzed with high signal-to-noise ratio using the same spectroscopic equipment.

### SUMMARY OF THE INVENTION

The invention provides a fiber optic multiplexer device and a method for selectively transferring electromagnetic radiation between a primary optical fiber and a plurality of secondary optical fibers without twisting or otherwise stressing the optical fibers. This is accomplished by interposing a mobile optical fiber between the primary optical fiber and the secondary optical fibers, which are stationary.

The device of the invention comprises a stationary frame to which one end of each of the primary and secondary optical fibers is attached at predetermined locations. The device further comprises a rotary frame, at least partially rotatable about a rotary frame axis of rotation, and a transfer optical fiber having a primary end and a secondary end attached to the rotary frame at predetermined locations. Depending on the locations of the attachment points and the relative orientations of the attached ends, the transfer optical fiber may have various geometries, including S-shaped, L-shaped and U-shaped, for example. The primary end of the transfer optical fiber attached to the rotary frame and the end of the primary optical fiber attached to the stationary frame are substantially coaxial with the rotary frame axis of rotation and are in close proximity to each other. The secondary end of the transfer optical fiber is located and configured such that it is moved along a circular arc and can be sequentially positioned substantially coaxial with and in close proximity to at least two secondary optical fibers by rotating the rotary frame about the rotary frame axis of rotation through at least one predetermined angle.

The device of the invention further comprises a means of rotating the rotary frame relative to the stationary frame through at least one predetermined angle. In a preferred embodiment, the device of the invention further comprises a computing device having a memory element with a stored algorithm operative to initialize and switch the device by repositioning the secondary end of the transfer optical fiber relative to the ends of the secondary optical fibers attached to the stationary frame.

In the initialized state of the device, the secondary end of the transfer optical fiber is positioned (by rotating the rotary frame) to be substantially coaxial with and in close proximity to the end of a first secondary optical fiber attached to the stationary frame. In this case, a light beam from the primary optical fiber is transferred, via the transfer optical fiber, to the first secondary optical fiber. Likewise, a light beam from the first secondary optic fiber is transferred to the primary optical fiber.

In a first switched state of the device, the secondary end of the transfer optical fiber is repositioned (by rotating the rotary frame through a first predetermined angle) substantially coaxial with and in close proximity to the end of a second secondary optical fiber attached to the stationary frame. In this case, a light beam from the primary optical fiber is transferred, via the transfer optical fiber, to the second secondary optical fiber. Likewise, a light beam from the second secondary optic fiber is transferred to the primary optical fiber. In order to switch to other switched states, the rotary frame is sequentially rotated through additional predetermined angles to reposition the secondary end of the transfer optical fiber substantially coaxial with and in close proximity to the end of other secondary optical fibers. The device may be configured to enable transfer of light beams between a primary optical fiber and any number of secondary optical fibers.

The method of the invention for selectively transferring electromagnetic radiation between a primary optical fiber and a plurality of secondary optical fibers comprises the steps of: providing the optical multiplexer described in paragraphs [0012]-[0015] comprising a stationary frame, a rotary frame, a transfer optical fiber, and a means of rotating the rotary frame through at least one predetermined angle relative to the stationary frame; initializing the provided device by rotating the rotary frame to position the secondary end of the transfer optical fiber substantially coaxial with and in close proximity to the end of a first secondary optical fiber attached to the stationary frame; and switching the provided device by rotating the rotary frame through a predetermined angle relative to the stationary frame to reposition the secondary end of the transfer optical fiber substantially coaxial with and in close proximity to the end of a second secondary optical fiber attached to the stationary frame.

The method of the invention may further comprise the step of: rotating the rotary frame through at least a second predetermined angle to reposition the secondary end of the transfer optical fiber substantially coaxial with and in close proximity to the end of at least a third secondary optical fiber. The device may be switched between any number of secondary optical fibers in any order.

The invention provides a fiber optic multiplexer that exhibits high efficiency for beam transmittance and low noise since distortion and stress of the optical fibers are avoided, and the distance that the beam traverses in air is small. The device is particularly useful for on-line analysis and control of a plurality of industrial processing solutions using the same spectroscopic analysis instrumentation.

Further features and advantages of the invention will be apparent to those skilled in the art from the following detailed description, taken together with the accompanying drawings.

### BRIEF DESCRIPTION OF THE DRAWINGS

FIG. 1 is a schematic representation of a one preferred embodiment of the fiber optic multiplexer of the invention, which provides switching between one primary and two secondary optical fibers via an S-shaped transfer optical fiber. This drawing is not to scale and some features have been enlarged for better depiction.

FIG. 2 is a schematic representation of another preferred embodiment of the fiber optic multiplexer of the invention, which provides switching between one primary and two secondary optical fibers via an L-shaped transfer optical fiber. This drawing is not to scale and some features have been enlarged for better depiction.

FIG. 3 is a schematic representation of yet another preferred embodiment of the fiber optic multiplexer of the invention, which provides switching between one primary and two secondary optical fibers via a U-shaped transfer optical fiber. This drawing is not to scale and some features have been enlarged for better depiction.

FIG. 4 is an engineering drawing of a preferred fiber optic multiplexer according to the invention, similar to that depicted in FIG. 1.

### DETAILED DESCRIPTION OF THE INVENTION

Terminology used in this document is generally known to those skilled in the art. The term “optical fiber” encompasses a single optical fiber as well as a bundle of optical fibers used together as a fiber optic element or probe. A preferred optical fiber for use with the invention has a single optical fiber core. Optical fibers generally have a circular cross-section and flat ends perpendicular to the optical fiber axis. In some cases, an optical fiber may comprise an optical window on one or both ends. Optical fibers may comprise a variety of optically transparent materials depending on the wavelength region involved. As applied to optical fibers, the term “end” generally denotes the end section of an optical fiber that is used for attachment but may also encompass the flat end of the optical fiber when the meaning is unambiguous. In this document, the term “geometric end” is sometimes used to distinguish the flat end of the optical fiber to avoid ambiguity. It is understood, however, that when the ends of optical fibers are said to be in close proximity, it is the geometric ends that are in close proximity.

The terms “electromagnetic radiation” and “light” generally have equivalent meanings. The term “electromagnetic radiation” encompasses light of any wavelength, including light in the ultraviolet (UV), visible, near infrared (NIR) and infrared (IR) wavelength ranges. A “beam” generally refers to light passed through an optical fiber.

The invention provides a fiber optic multiplexer device and a method for selectively transferring, i.e., switching, electromagnetic radiation between a primary optical fiber and a plurality of secondary optical fibers without twisting or otherwise stressing the optical fibers. The terms “primary” and “secondary” denote “common” and “branched” optical fibers, respectively, and do not imply a particular direction for light passing through the optical multiplexer. The device may be configured to accommodate any number of secondary optic fibers and may comprise any suitable material or materials of construction.

The fiber optic multiplexer of the invention for selectively transferring electromagnetic radiation between a primary optical fiber and a plurality of secondary optical fibers comprises: (1) a stationary frame to which one end of each of the primary and secondary optical fibers is attached at predetermined locations; (2) a rotary frame attached to said stationary frame so as to be at least partially rotatable about a rotary frame axis of rotation; (3) a means of rotating said rotary frame through a predetermined angle relative to said stationary frame; and (4) a transfer optical fiber having a primary end and a secondary end attached to said rotary frame such that the primary end is substantially coaxial with the rotary frame axis of rotation and is substantially coaxial with and in close proximity to the end of the primary optical fiber attached to said stationary frame, and the secondary end is moved along a circular arc and is sequentially positioned coaxial with and in close proximity to a first and a second secondary optical fiber by rotating the rotary frame through the predetermined angle.

In the initialized state of the device, the secondary end of the transfer optical fiber is substantially coaxial with and in close proximity to the end of the first secondary optical fiber attached to the stationary frame. Rotation of the rotary frame through a predetermined angle switches the device by repositioning the secondary end of the transfer optical fiber substantially coaxial with and in close proximity to the end of the second secondary optical fiber attached to the stationary frame. The device may be switched to other states by sequentially rotating the rotary frame through additional predetermined angles to reposition the secondary end of the transfer optical fiber substantially coaxial with and in close proximity to the end of other secondary optical fibers. It should be understood that the words “rotate”, “rotation” and “rotating” as used in this document always denote rotary movement of the rotary frame through an angle of less than 360° to initialize or switch the device.

In a preferred embodiment, the device of the invention further comprises: (5) a computing device having a memory element with a stored algorithm operative to initialize the fiber optic multiplexer by positioning the secondary end of said transfer optical fiber attached to said rotary frame substantially coaxial with and in close proximity to the end of the first secondary optical fiber attached to said stationary frame, and to switch the fiber optic multiplexer by repositioning the secondary end of said transfer optical fiber substantially coaxial with and in close proximity to the end of the second secondary optical fiber attached to said stationary frame. Initialization comprises re-establishment of a predetermined device state, and may include optimization of the device performance in terms of signal-to-noise ratio.

The computing device may comprise a computer with integrated components, or may comprise separate components, a microprocessor and a memory device that includes a memory element, for example. The memory element may be any one or a combination of available memory elements, including a computer hard drive, a microprocessor chip, a read-only memory (ROM) chip, a programmable read-only memory (PROM) chip, a magnetic storage device, a computer disk (CD) and a digital video disk (DVD), for example. The memory element may be an integral part of the computing device or may be a separate device.

In the fiber optic multiplexer of the invention, electromagnetic radiation is preferably transferred directly between the optical fibers, but may be transferred via one or more collimating lenses attached to the ends of the optical fibers.

The fiber optic multiplexer of the invention may comprise any suitable material. The rotary and stationary frames of the invention preferably comprise a metal or metals that are readily machined, formed or cast but may comprise other metals or materials, composites, for example. Suitable metals include aluminum, aluminum alloys, titanium, titanium alloys, and various types of steel, including stainless steels, for example. As those skilled in the art will appreciate, the rotary and stationary frames may have a wide range of suitable configurations, and may be monolithic or comprise a plurality of parts.

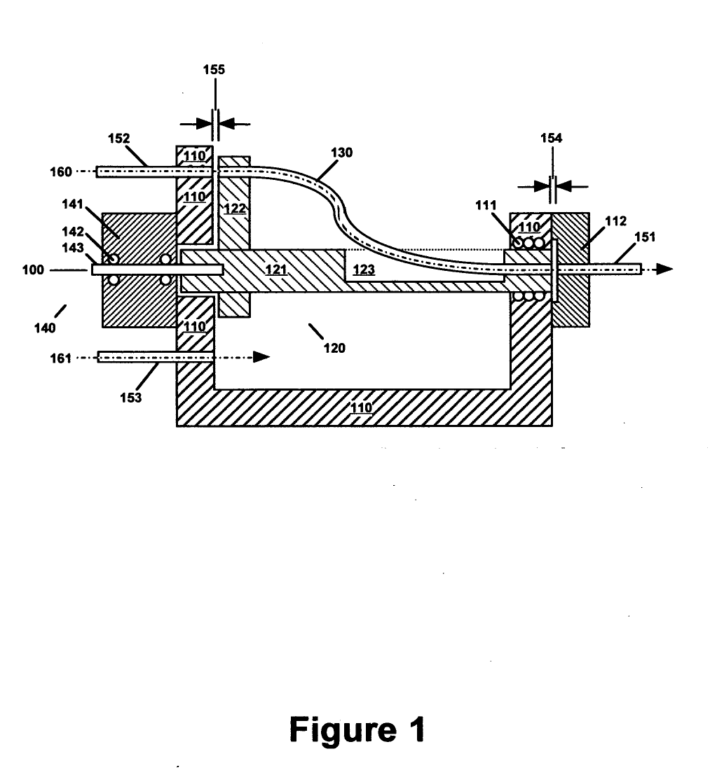

FIG. 1 shows a schematic cross-section of one preferred fiber optic multiplexer that employs an S-shaped optical fiber to selectively transfer electromagnetic radiation between a primary optical fiber and a plurality of secondary optical fibers according to the invention. The optical multiplexer depicted comprises a stationary frame 110, a rotary frame 120, a transfer optical fiber 130, and a means 140 of rotating rotary frame 120 about rotary frame axis of rotation 100 through a predetermined angle relative to stationary frame 110.

Rotary frame 120 comprises an axle 121 and an arm 122, which may be separate parts (as depicted) or a monolithic part. Axle 121 preferably includes a cutout 123 enabling the primary end of transfer optical fiber 130 to be attached to one end of axle 121 coaxial with rotary frame axis of rotation 100. In the device of FIG. 1, the secondary end of transfer optical fiber 130 is attached to arm 122 with its axis parallel with rotary frame axis of rotation 100. In this case, secondary optical fibers 152 and 153 are also attached (to stationary frame 110) with their axes parallel with rotary frame axis of rotation 100 so that the primary and secondary optical fibers can be positioned coaxially. Within the scope of the invention, this may also be accomplished by attaching the secondary end of the transfer optical fiber and the ends of the secondary optical fibers with all of the axes at a predetermined angle (rather than parallel) to the rotary frame axis of rotation. Any suitable means of attaching optical fibers may be used. Standard fittings for attaching optical fibers are known to those skilled in the art. Rotary frame 120 may have any suitable configuration. In particular, arm 122 may be any suitable shape.

As depicted in FIG. 1, stationary frame 110 is C-shaped but may have any suitable configuration, and may be monolithic or comprise separate parts attached together by any suitable method. Stationary frame 110 preferably includes one or more ball bearings 111 or other devices (bushings or roller bearings, for example) for allowing rotary frame 120 to be smoothly rotated by a rotation means 140. As depicted in FIG. 1, rotation means 140 may be an electric motor 141 with its body attached to stationary frame 110 and its shaft 143 attached concentrically to axle 121 of rotary frame 120. Bearings 142 of motor 141 may be used to support one end of axle 121, or separate or auxiliary bearings or bushings may be used between axle 121 and stationary frame 110.

The device of FIG. 1 provides switching between a primary optical fiber 151 and two secondary optical fibers 152 and 153, which have one end attached to stationary frame 110. Primary optical fiber 151 is secured via a holder 112, which may be a separate part attached to stationary frame 110 (as shown) or an integral part of stationary frame 110. The end of primary optical fiber 151 attached to stationary frame 110 is substantially coaxial with and in close proximity to the primary end of transfer optical fiber 130.

In the device of FIG. 1, the ends of secondary optical fibers 152 and 153 attached to stationary frame 110 have axes that are substantially parallel to rotary frame axis of rotation 100 and are located at substantially the same distance from rotary frame axis of rotation 100 as the axis of the secondary end of transfer optical fiber 130. This distance may be any suitable distance, depending on the number of secondary optical fibers included in the device and the space required for the rotation means. The geometric ends of transfer optical fiber 130, primary optical fiber 151, and secondary optical fibers 152 and 153 may be attached flush with the surfaces of the respective frames 110 and 120, or may be offset by a predetermined distance so as to provide a desired spacing. Gaps 154 and 155 between the ends of the coaxial optical fibers in the device of the invention are typically less than one millimeter. It will be apparent to those skilled in the art that transfer optical fiber 130 may have various alternative geometric shapes, and that the axes of secondary optical fibers 152 and 153 and the secondary end of transfer optical fiber 130 may be at an angle to (rather than parallel to) rotary frame axis of rotation 100.

In the initialized state of the device as depicted in FIG. 1, the attached end of secondary optical fiber 152 is coaxial with and in close proximity to the secondary end of transfer optical fiber 130. In this case, a light beam 160 from secondary optical fiber 152 is transferred to primary optical fiber 151 via transfer optical fiber 130 with minimal loss in intensity, and a light beam 161 from secondary optical fiber 153 is not transferred to primary optical fiber 151. A light beam may also be passed through the device in the opposite direction.

The device of FIG. 1 is switched by rotating rotary frame 120 by 180° relative to stationary frame 110 so that the secondary end of transfer optical fiber 130 is coaxial with and in close proximity to the attached end of secondary optical fiber 153. In this case (not shown), light beam 161 would be transferred from secondary optical fiber 153 to primary optical fiber 151 via transfer optical fiber 130 with minimal loss in intensity, and light beam 160 from secondary optical fiber 152 would not be transferred to primary optical fiber 151. Switching of the device is accomplished without distortion of the optical fibers so that a high signal-to-noise ratio is provided.

Suitable devices for rotating rotary frame 120 with the high precision needed for the optical multiplexer of the invention are well-known to those skilled in the art. Such devices include stepper motors and servomotors, for example. A simple DC motor may also be used with an encoder to monitor the angular position of axle 121. Motor 141 may also be attached to axle 121 via a suitable gearbox, or a pulley and drive belt, such as a timing belt Any suitable device may be used to rotate the rotary frame through the predetermined angle, including but not limited to those selected from the group consisting of stepper motor, servo motor, DC motor, encoder, coupling, gearbox, drive belt, timing belt, pulley, and combinations thereof.

The ends of the various optical fibers may be attached to the stationary and rotary frames of the invention by any suitable means. The ends of the optical fibers may be press fitted into holes in frames 110 and 120, for example, but are preferably held in place with a suitable fastener (not shown), a standard fiber optic fitting, or an o-ring or ferrule fitting, for example. Standard fittings for attaching optical fibers are commercially available. Such fittings are typically installed in threaded holes.

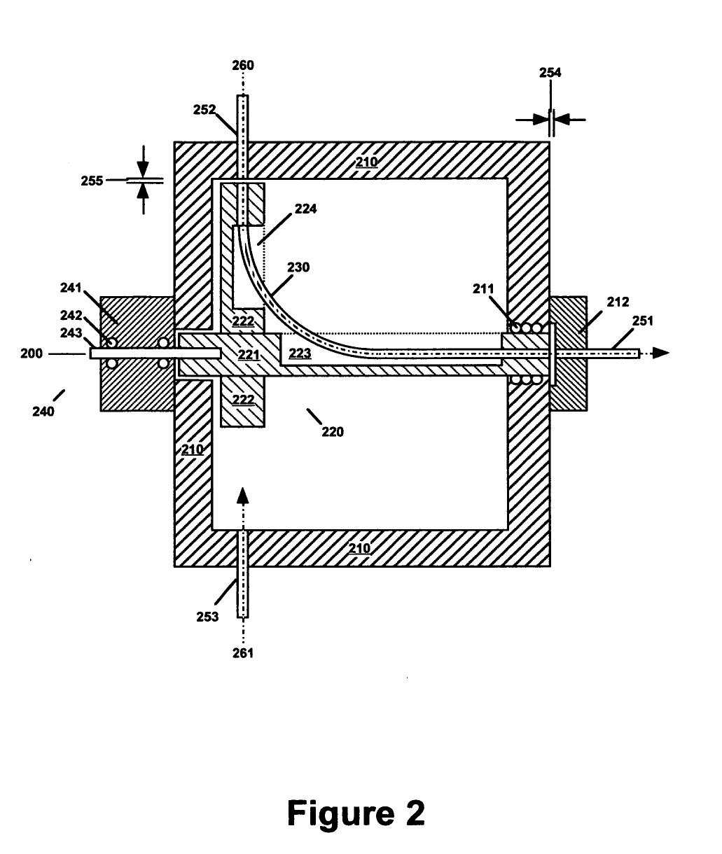

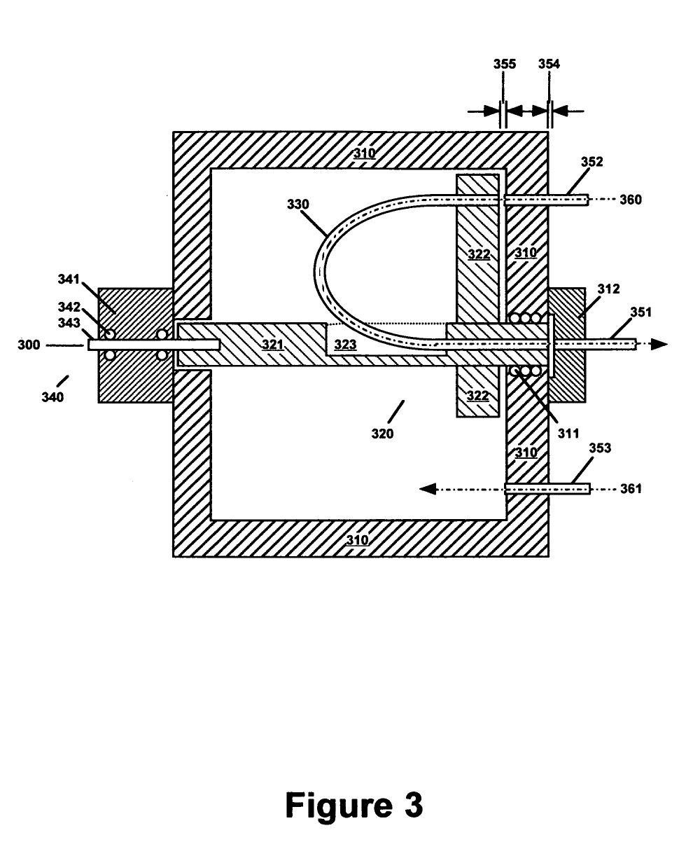

FIGS. 2 and 3 are schematic representations of preferred embodiments of the fiber optic multiplexer of the invention that provide switching between one primary and a plurality of secondary optical fibers via an L-shaped and a U-shaped transfer optical fiber, respectively. For these figures, the last two digits of the drawing label numbers generally identify the same components of the optical multiplexer of the invention as in FIG. 1. The discussion for FIG. 1 is also applicable to FIGS. 2 and 3.

For the device of FIG. 2, the secondary end of transfer optical fiber 230 is attached to arm 222 of rotary frame 220 with its axis perpendicular to rotary frame axis of rotation 200. A cutout 224 in arm 222 accommodates the smooth curvature of transfer optical fiber 230. Secondary optical fibers 252 and 253 are attached to stationary frame 210 such that their geometric ends are located at substantially the same predetermined distance from rotary frame axis of rotation 200, providing a sufficiently small gap 255 between transfer optical fiber 230 and secondary optical fibers 252 and 253. In the configuration depicted in FIG. 2, light beam 260 from secondary optical fiber 252 is transferred via transfer optical fiber 230 to primary optical fiber 251, but light beam 261 from secondary optical fiber 253 is not transferred. Optionally, the axes of the attached ends of secondary optical fibers 252 and 253 and the secondary end of transfer optical fiber 230 may be inclined at the same angle relative to rotary frame axis of rotation 200 and still provide coaxial alignment and close proximity between the end of transfer optical fiber 230 and the ends of secondary optical fibers 252 and 253.

For the device of FIG. 3, the secondary end of transfer optical fiber 330 is attached to arm 322 of rotary frame 320 with its axis parallel to and a predetermined distance from rotary frame axis of rotation 300. Secondary optical fibers 352 and 353 are attached to stationary frame 310 such that their axes are parallel to and located at the predetermined distance from rotary frame axis of rotation 200. The geometric ends of secondary optical fibers 352 and 353 lie in a plane substantially perpendicular to rotary frame axis of rotation 300, which is offset relative to the geometric end of transfer optical fiber 330 so as to provide a desired gap 355. In the configuration depicted in FIG. 3, light beam 360 from secondary optical fiber 352 is transferred via transfer optical fiber 330 to primary optical fiber 351, but light beam 361 from secondary optical fiber 353 is not transferred. Optionally, the axes of the attached ends of secondary optical fibers 352 and 353 and the secondary end of transfer optical fiber 330 may be inclined at the same angle relative to rotary frame axis of rotation 300 and still provide coaxial alignment and close proximity between the end of the transfer optical fiber and the ends of the secondary optical fibers.

The method of the invention for selectively transferring electromagnetic radiation between a primary optical fiber and a plurality of secondary optical fibers, comprises the steps of: (1) providing an optical multiplexer, comprising (a) a stationary frame to which one end of each of the primary and secondary optical fibers is attached, (b) a rotary frame attached to the stationary frame so as to be at least partially rotatable about a rotary frame axis of rotation, (c) a means of rotating the rotary frame through a predetermined angle relative to the stationary frame, and (d) a transfer optical fiber having a primary end and a secondary end attached to the rotary frame such that the primary end is substantially coaxial with the rotary frame axis of rotation and is substantially coaxial with and in close proximity to the end of the primary optical fiber attached to the stationary frame, and the secondary end is moved along a circular arc and can be sequentially positioned coaxial with and in close proximity to the ends of at least a first and a second secondary optical fiber by rotating the rotary frame; (2) initializing the optical multiplexer by rotating the rotary frame to position the secondary end of the transfer optical fiber attached to the rotary frame substantially coaxial with and in close proximity to the end of the first secondary optical fiber attached to the stationary frame; and (3) switching the optical multiplexer by rotating the rotary frame through the predetermined angle to reposition the secondary end of the transfer optical fiber substantially coaxial with and in close proximity to the end of the second secondary optical fiber attached to the stationary frame.

The method of the invention may further comprise the step of: (4) rotating the rotary frame through at least a second predetermined angle to reposition the secondary end of said transfer optical fiber substantially coaxial with and in close proximity to the end of at least a third secondary optical fiber.

### Description of a Preferred Embodiment

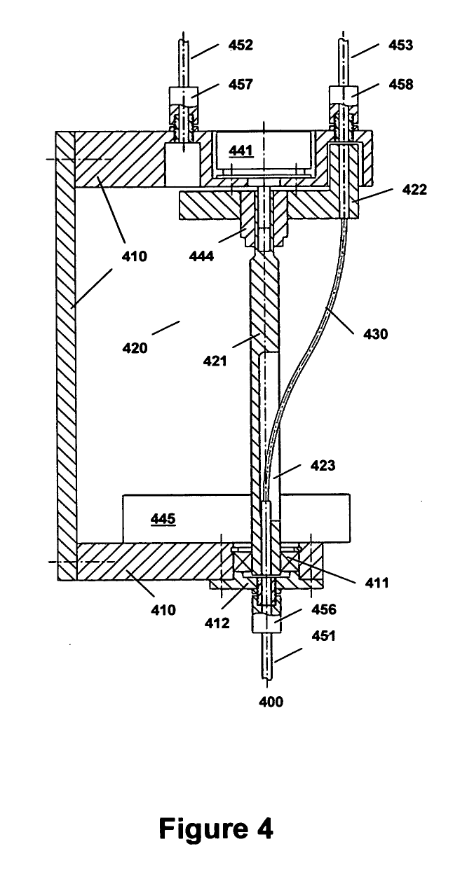

FIG. 4 is an engineering cross-section drawing (1:1.5 scale) of a preferred fiber optic multiplexer according to the invention. The last two digits of the drawing number labels for FIG. 4 are keyed to those of FIG. 1. Although only two are depicted in the cross-section drawing, the preferred fiber optic multiplexer of FIG. 4 accommodates up to ten secondary optical fibers, providing ten-channel operation. Primary optical fiber 451 and secondary optical fibers 452 and 453 (and the additional secondary optical fibers not depicted) are attached to stationary frame 410 via standard fiber optic fittings 456, 457 and 458, screwed into threaded holes. Fiber optic fitting 456 is attached to stationary frame 410 via holder 412, which is attached to stationary frame 410 via machine screws. Fiber optic fittings 457 and 458 are attached directly to stationary frame 410, which comprises three parts joined together by machine screws.

For the preferred fiber optic multiplexer of FIG. 4, rotary frame 420 comprises an axle 421, and an arm 422 to which the secondary end of transfer optical fiber 430 is attached by slip fitting into a hole and fastening with a setscrew. Axle 421 includes a cutout area 423 that enables the primary end of transfer optical fiber 430 to be attached concentric with rotary frame axis of rotation 400 (via a slip fitting and a set screw). Stationary frame 410 and rotary frame 420 preferably comprise an aluminum alloy but may be constructed of any suitable material or combination of materials. Likewise, those skilled in the art will recognize that stationary frame 410 and rotary frame 420 may be configured in numerous ways within the scope of the invention.

For the preferred fiber optic multiplexer of FIG. 4, precise rotation of rotary frame 420 relative to stationary frame 410 is provided by a DC motor 441 in conjunction with an encoder 445. Motor 441 is attached to stationary frame 410 via machine screws, and the shaft of motor 441 is concentrically attached to axle 421 via coupling 444. Axle 421 is attached to stationary frame 410 via ball bearing 411 and the bearings of motor 441.

The efficacy of the fiber optic multiplexer of the invention was demonstrated by using the preferred ten-channel fiber optic multiplexer depicted in FIG. 4 and a single NIR spectrometer to perform spectroscopic analysis of a diluted sulfuric/peroxide (DSP) solution flowing at 500 mL/minute through three NIR analysis cells in series. Only four channels of the ten available were used for this demonstration. Light from the light source of the spectrometer was projected onto four optical fibers, three of which conveyed an analysis beam to one of the three analysis cells and one of which conveyed a reference beam directly to a secondary input of the optical multiplexer. After passing through one of the analysis cells, each of the analysis beams was conveyed via a secondary optical fiber to a separate input of the optical multiplexer. The output beam from the optical multiplexer was conveyed via a primary optical fiber to the spectrometer detector. By switching the optical multiplexer, the analysis beams from each of the three cells and the reference beam were sequentially conveyed to the spectrometer detector.

Table 1 gives the compositions of the solutions analyzed. The temperature of the solution was controlled via a circulating water bath and was varied in the range from 20° to 30° C. The NIR spectral data were manipulated chemometrically to determine the concentrations of sulfuric acid and hydrogen peroxide in the solutions.

TABLE 1
Solutions Analyzed by NIR Spectroscopy
Using the Optical Multiplexer of the Invention

| Solution | H₂O₂ (wt %) | H₂SO₄ (wt %) | DI Water (wt %) |
|---|---|---|---|
| 1 | 5.00 | 8.00 | 87.00 |
| 2 | 1.00 | 11.00 | 88.00 |
| 3 | 2.00 | 8.00 | 90.00 |
| 4 | 4.00 | 6.00 | 90.00 |
| 5 | 0.00 | 6.00 | 94.00 |
| 6 | 5.00 | 13.00 | 82.00 |
| 7 | 3.00 | 13.00 | 84.00 |
| 8 | 6.00 | 11.00 | 83.00 |

Table 2 and 3 summarize the NIR spectroscopy results for analysis of hydrogen peroxide and sulfuric acid, respectively, for each of the three channels corresponding to three cells in series selected by the preferred optical multiplexer of the invention. Consistent results for all three channels (cells) and good agreement with the actual concentrations in all cases is evident. The sulfuric acid analyses were typically accurate within 0.03 wt % (deviations never exceeded 0.06 wt %). The hydrogen peroxide analyses were generally accurate within 0.1 wt % (one deviation of 0.15 wt %).

TABLE 2
NIR Spectroscopy Results for Three-Channel
Hydrogen Peroxide Analysis

| Actual wt % | Channel 1 | Channel 2 | Channel 3 |
|---|---|---|---|
| 5.00 | 5.01 | 5.02 | 5.05 |
| 1.00 | 1.07 | 1.08 | 1.08 |
| 2.00 | 2.08 | 2.04 | 2.06 |
| 4.00 | 4.02 | 4.04 | 3.97 |
| 0.00 | −0.10 | −0.11 | −0.08 |
| 5.00 | 4.91 | 4.92 | 4.85 |
| 3.00 | 3.01 | 3.02 | 3.04 |
| 6.00 | 6.00 | 5.98 | 6.05 |

TABLE 3
NIR Spectroscopy Results for Three-Channel Sulfuric Acid Analysis

| Actual wt % | Channel 1 | Channel 2 | Channel 3 |
|---|---|---|---|
| 8.00 | 7.99 | 7.98 | 7.94 |
| 11.00 | 11.05 | 11.05 | 11.02 |
| 8.00 | 7.99 | 8.00 | 7.99 |
| 6.00 | 6.02 | 6.03 | 6.05 |
| 6.00 | 5.98 | 5.97 | 5.99 |
| 13.00 | 13.00 | 12.99 | 13.04 |
| 13.00 | 12.97 | 12.97 | 12.96 |
| 11.00 | 11.02 | 11.01 | 11.00 |

The efficacy of the fiber optic multiplexer of the invention was further demonstrated by comparing the average noise measured for light passed through the preferred fiber optic multiplexer of the invention with that measured for light from a multi-core fiber projected on a single-core fiber. The noise measured for the optical multiplexer of the invention was 0.25 milliabsorbance units, whereas that measured for the multicore fiber was six times higher (1.56 milliabsorbance units).

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

1. A fiber optic multiplexer for selectively transferring electromagnetic radiation between a primary optical fiber and a plurality of secondary optical fibers, comprising:
a stationary frame to which one end of each of the primary and secondary optical fibers is attached at predetermined locations;
a rotary frame comprising a rotary frame arm and a rotary frame axle attached to said stationary frame so as to be at least partially rotatable about the rotary frame axle;
a means of rotating said rotary frame through a predetermined angle relative to said stationary frame comprising a motor having a motor axle coaxially attached to the rotary frame axle; and
a transfer optical fiber having a primary end and a secondary end attached to said rotary frame such that the primary end is substantially coaxial with the rotary frame axle and is substantially coaxial with and in close proximity to the end of the primary optical fiber attached to the stationary frame, and the secondary end is attached to the rotary frame arm and is moved along a circular arc and is sequentially positioned coaxial with and in close proximity to a first and a second secondary optical fiber by rotating the rotary frame through the predetermined angle.

2. The fiber optic multiplexer of claim 1, wherein said rotary frame is attached to said stationary frame via a device selected from the group consisting of ball bearing, roller bearing, bushing, and combinations thereof.

3. The fiber optic multiplexer of claim 1, wherein the motor is selected from the group consisting of stepper motor, servo motor, and DC motor.

4. The fiber optic multiplexer of claim 1, further comprising:
a computing device having a memory element with a stored algorithm operative to initialize the fiber optic multiplexer by positioning the secondary end of said transfer optical fiber attached to the rotary frame arm substantially coaxial with and in close proximity to the end of the first secondary optical fiber attached to said stationary frame, and to switch the fiber optic multiplexer by repositioning the secondary end of said transfer optical fiber substantially coaxial with and in close proximity to the end of the second secondary optical fiber attached to said stationary frame.

5. The fiber optic multiplexer of claim 4, wherein the memory element is selected from the group consisting of computer hard drive, microprocessor chip, read-only memory (ROM) chip, programmable read-only memory (PROM) chip, magnetic storage device, computer disk (CD), digital video disk (DVD), and combinations thereof.

6. A method for selectively transferring electromagnetic radiation between a primary optical fiber and a plurality of secondary optical fibers, comprising the steps of:
providing an optical multiplexer, comprising
a stationary frame to which one end of each of the primary and secondary optical fibers is attached,
a rotary frame comprising a rotary frame arm and a rotary frame axle attached to the stationary frame so as to be at least partially rotatable about the rotary frame axle,
a means of rotating the rotary frame through a predetermined angle relative to the stationary frame comprising a motor having a motor axle coaxially attached to the rotary frame axle, and
a transfer optical fiber having a primary end and a secondary end attached to the rotary frame such that the primary end is substantially coaxial with the rotary frame axle and is substantially coaxial with and in close proximity to the end of the primary optical fiber attached to the stationary frame, and the secondary end is attached to the rotary frame arm and is moved along a circular arc and can be sequentially positioned coaxial with and in close proximity to the ends of at least a first and a second secondary optical fiber by rotating the rotary frame;
initializing the optical multiplexer by rotating the rotary frame to position the secondary end of the transfer optical fiber attached to the rotary frame arm substantially coaxial with and in close proximity to the end of the first secondary optical fiber attached to the stationary frame; and
switching the optical multiplexer by rotating the rotary frame through the predetermined angle to reposition the secondary end of the transfer optical fiber substantially coaxial with and in close proximity to the end of the second secondary optical fiber attached to the stationary frame.

7. The method of claim 6, further comprising the step of:
rotating the rotary frame through at least a second predetermined angle to reposition the secondary end of the transfer optical fiber substantially coaxial with and in close proximity to the end of at least a third secondary optical fiber.

8. A fiber optic multiplexer for selectively transferring electromagnetic radiation between a primary optical fiber and a plurality of secondary optical fibers, comprising:
a stationary frame to which one end of each of the primary and secondary optical fibers is attached;
a rotary frame comprising a rotary frame arm and a rotary frame axle attached to said stationary frame so as to be at least partially rotatable about the rotary frame axle;
a means of rotating said rotary frame through a predetermined angle relative to said stationary frame comprising a motor having a motor axle coaxially attached to the rotary frame axle and an encoder device mounted directly on the rotary frame axle to indicate the angular position of said rotary frame relative to said stationary frame; and
a transfer optical fiber having a primary end and a secondary end attached to said rotary frame such that the primary end is substantially coaxial with the rotary frame axle and is substantially coaxial with and in close proximity to the end of the primary optical fiber attached to said stationary frame, and the secondary end is attached to the rotary frame arm and moves along a circular arc when said rotary frame is rotated about the rotary frame axle,
wherein the fiber optic multiplexer is initialized by positioning the secondary end of said transfer optical fiber attached to said rotary frame arm substantially coaxial with and in close proximity to the end of a first secondary optical fiber attached to said stationary frame, and rotation of said rotary frame through the predetermined angle switches the fiber optic multiplexer by repositioning the secondary end of said transfer optical fiber substantially coaxial with and in close proximity to the end of a second secondary optical fiber attached to said stationary frame.

9. The fiber optic multiplexer of claim 8, wherein rotation of said rotary frame through at least a second predetermined angle repositions the secondary end of said transfer optical fiber substantially coaxial with and in close proximity to the end of at least a third secondary optical fiber.

10. The fiber optic multiplexer of claim 8, wherein said rotary frame is attached to said stationary frame via a device selected from the group consisting of ball bearing, roller bearing, bushing, and combinations thereof.

11. The fiber optic multiplexer of claim 8, wherein the motor is selected from the group consisting of stepper motor, servo motor, and DC motor.

12. The fiber optic multiplexer of claim 8, further comprising:
a computing device having a memory element with a stored algorithm operative to initialize and switch the fiber optic multiplexer.

13. The fiber optic multiplexer of claim 12, wherein the memory element is selected from the group consisting of computer hard drive, microprocessor chip, read-only memory (ROM) chip, programmable read-only memory (PROM) chip, magnetic storage device, computer disk (CD), digital video disk (DVD), and combinations thereof.

14. The fiber optic multiplexer of claim 1, wherein said means of rotating said rotary frame through the predetermined angle further comprises an encoder device mounted directly on the rotary frame axle to indicate the angular position of said rotary frame relative to said stationary frame.
